(19) United States
(12) Patent Application Publication
(10) Pub. No.: US 2004/0115093 A1
(43) Pub. Date: Jun. 17, 2004

(54) Apparatus for monitoring specific substances in a fluid

(76) Inventors: Kuo-Jeng Wang, Kaohsiung City (TW); Yu-Ru Yu, Chu-Pei City (TW)

Correspondence Address: Nath & Associates, PLLC, Sixth Floor, 1030 15th Street, N.W., Washington, DC, 20005, US

(21) Appl. No.: 10/317,175

(22) Filed: Dec. 12, 2002

(51) Int. Cl. G01N 21/03

(52) U.S. Cl. 422/58; 422/55; 422/56; 422/82.05; 436/164; 436/901; 436/165; 436/169

(57) ABSTRACT

An apparatus for monitoring specific substances in a fluid is provided. The apparatus of the present invention includes a housing, a tray, transmission means, a cylindrical transparent reservoir, a cylindrical holder having a plurality of hollow frames around the surrounding thereof each of which holding a test paper, and an optical scanning assembly. The tray is disposed in the housing and rotated by the transmission means. The cylindrical transparent reservoir contains a fluid sample to be analyzed and is held on the tray so as to synchronously rotate with the tray. The cylindrical holder is disposed in the cylindrical transparent reservoir. The optical scanning assembly is fastened beside the cylindrical transparent reservoir for capturing an image of a pattern displayed on each test paper in response to at least one specific substance in the fluid sample upon rotating the cylindrical transparent reservoir and converting the image into electronic signals. Thereby, the specific substances in the fluid sample are analyzed and identified via the image information captured from each test paper.

### BACKGROUND OF THE INVENTION

1. Field of the Invention

The present invention relates to an apparatus for monitoring specific substances in a fluid, and more particularly, to an apparatus for monitoring specific substances in fluid via an image capturing processing technology.

2. Description of the Prior Art

Over the past decade, there has been an increased need and demand for analysis of various biological specimens, for purposes ranging from pregnancy testing to drug analysis. Considerable time and effort has been expended by way of devising systems and analytic techniques to ensure reliable testing and accurate results.

Moreover, with increasing rise in the use of abuse-type drugs, the need for detecting and identifying those drugs and their metabolites is becoming more important. With this need, many more tests are required to monitor the use of abuse-type drugs.

Thin layer chromatography (TLC) screening procedures for detecting drugs in urine require the careful preparation of a test specimen and then a skillful application of that test specimen to a plate placed into a developing chamber. Once the plate is removed from the chamber and dried, it is sprayed with visualization reagents. Location and color of spots are compared with those of known standards. Qualitative judgements are made as to the presence of various drugs in the unknown sample. The procedure is tedious, time consuming and requires skilled personnel to interpret the results.

The EMIT (Enzyme Multiplied Immuno-chemical Test) procedure is a semi-quantitative immuno-assay for drugs of abuse in biological fluids. The laboratory test requires trained technicians to perform and the equipment necessarily costs several thousands of dollars.

The RIA (Radio-Immuno-Assay) procedure is a sensitive and quantitative laboratory procedure for detecting drugs of abuse. The various immunochemicals are labeled with radioactive compounds and require special care in their use and disposal. A license is required from the government to use this laboratory procedure because of the presence of radioactive materials. The GLC (Gas-Liquid Chromatography) procedure can provide the highest degree of accuracy in drug analysis. However, the necessary equipment is expensive and the procedure is complicated. Consequently, highly trained personnel are required for its use.

Each of these well-known procedures requires skilled technicians and relatively sophisticated equipment. Consequently, the testing procedure is necessarily expensive.

An alternate method for abuse-type drug testing in a biological fluid is utilizing a drug abuse test paper, which is prepared in accordance with unique procedure whereby pH insensitivity and unique color change sensitivities to test fluids are obtained. The color change of the drug abuse test paper sensitive to one specific substance existing in the fluid specimen collected from a test subject applied on the drug abuse test paper is simply verified by visual judgement. This abuse-type drug testing is rapid and convenient. However, it is not convincing for concluding the test subject has used abuse-type drugs.

Accordingly, it is an intention to provide means capable of analyzing and identifying specific substances in a fluid sample, which can alleviate the drawbacks encountered in the conventional methods.

### SUMMARY OF THE INVENTION

It is one objective of the present invention to provide an apparatus for monitoring specific substances in a fluid, which can qualitatively and quantitatively monitoring specific substances in a fluid sample via an image capturing/processing technology.

It is another objective of the present invention to provide an apparatus for monitoring specific substances in a fluid, which can rapidly and accurately analyze a fluid sample qualitatively and quantitatively.

It is yet another objective of the present invention to provide an apparatus for monitoring specific substances in a fluid, which is easily operated, user-friendly and low cost.

It is a further objective of the present invention to provide an apparatus for monitoring specific substances in a fluid, which can be designed to a portable device, facilitating a user to carry about with himself/herself.

It is still a further objective of the present invention to provide an apparatus for monitoring specific substances in a fluid, which can be used to test drugs of abuse in a biological specimen obtained from a test subject.

It is still a further objective of the present invention to provide an apparatus for monitoring specific substances in a fluid, which can be used to simultaneously analyze different fluid samples.

In order to achieve the above objectives of this invention, the present invention provides an apparatus for monitoring specific substances in a fluid, which comprises a housing, a tray, transmission means, a cylindrical transparent reservoir, a cylindrical holder having a plurality of hollow frames formed around the surrounding thereof, and an optical scanning assembly. The tray is disposed in the housing and rotated by the transmission means. The cylindrical transparent reservoir contains a fluid sample to be analyzed and is held on the tray so that the cylindrical transparent reservoir is synchronously rotated with the tray. The cylindrical holder is disposed in the cylindrical transparent reservoir, and each of the hollow frames thereof holds a test paper and the level of the fluid sample exceeds the bottom of each test paper so that the fluid sample is absorbed by each test paper via capillary action. The test paper is designed to show a unique color change in a predetermined location thereon in response to at least one specific substance in the fluid sample. The optical scanning assembly is fastened beside the cylindrical transparent reservoir for capturing an image of a pattern displayed on each test paper in response to the fluid sample upon rotating the cylindrical transparent reservoir, and converting the image to electronic signals. Thereby, the specific substances contained in the fluid sample are analyzed and identified via the image information captured from each test paper. The present invention provides an apparatus capable of qualitatively and quantitatively monitoring specific substances in a fluid by the image capturing/processing technology, which is rapid, accurate, and inexpensive. Hence, the present invention is suitable for abuse-type drug test.

### BRIEF DESCRIPTION OF THE DRAWINGS

The objectives and features of the present invention as well as advantages thereof will become apparent from the following detailed description, considered in conjunction with the accompanying drawings.

FIG. 1 is a schematic perspective view of the present apparatus in accordance with a first preferred embodiment of the present invention;

FIG. 2A is an enlarged top view of a tray associated with transmission means in accordance with the first preferred embodiment;

FIG. 2B is an enlarged perspective view of a cylindrical holder having test papers held therein in accordance with the first preferred embodiment;

FIG. 2C is an enlarged top view of an optical scanning assembly in accordance with the first preferred embodiment;

FIG. 3 is an enlarged perspective view of a cylindrical holder in accordance with a second preferred embodiment; and

FIG. 4 is a schematic view of an abuse-type drug test paper having a pattern thereon in response to a tested fluid sample.

### DESCRIPTION OF THE PREFERRED EMBODIMENTS

The present invention provides an apparatus for monitoring specific substances in a fluid, which associates with an image capturing and processing technology to analyze and identify the specific substances in the fluid qualitatively and quantitatively. The present apparatus is suitable for the test of drugs of abuse by monitoring a biological fluid such as a urine specimen collected from a test subject. The present apparatus can be made sensitive enough to reliably indicate that the subject has used drugs when predetermined quantities of illegal drugs are present in the subject's biological specimen fluid, for example the urine specimen fluid. The present apparatus is inexpensive and easily operated that does not need a careful preparation of the testing sample. Therefore, the present apparatus can replace laboratory testing as a legally defensible mans of confirming the presence of illegal drugs.

The apparatus of the present invention will be described in detail in accordance with the following preferred embodiments with reference to accompanying drawings. Before the detailed description of the present invention, it should be noted all the drawing provided herein are not prepared in proportion to the real dimensions, however only used to clearly illustrate the configuration of the present apparatus.

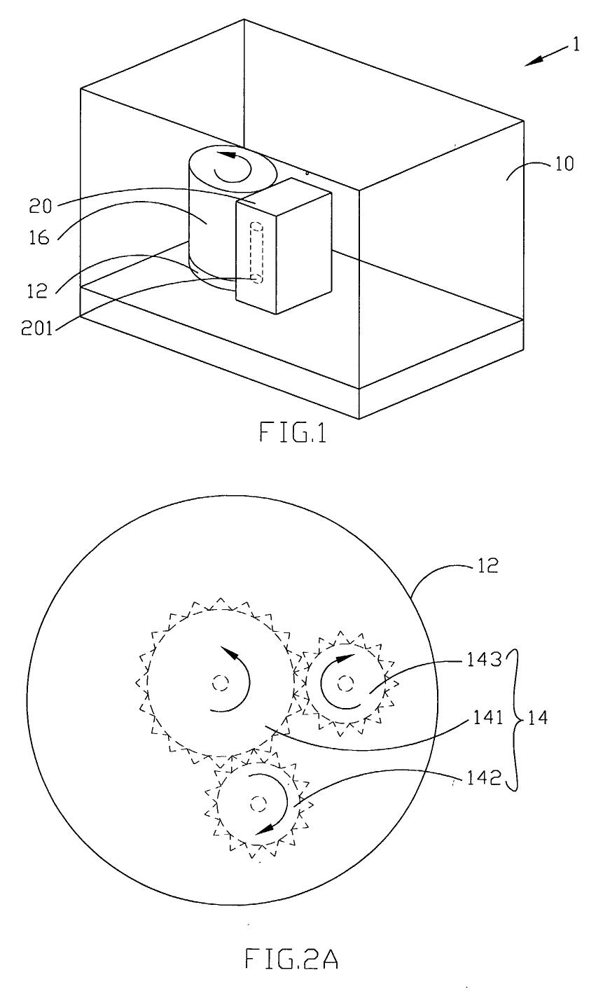

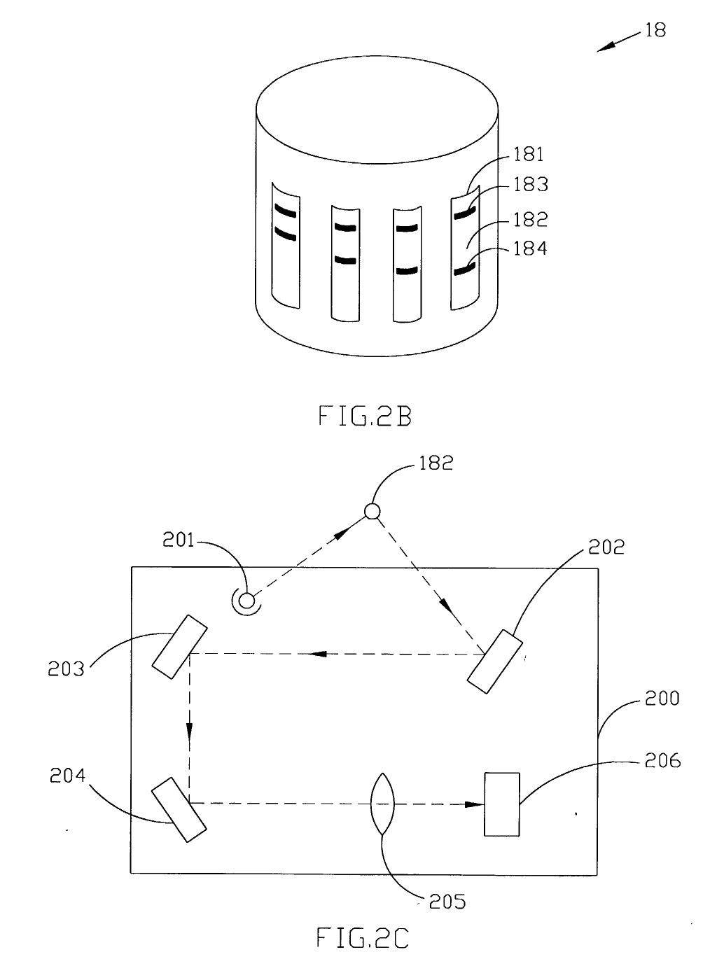

FIG. 1 is a schematic perspective view of the present apparatus 1 in accordance with a first preferred embodiment, which comprises a housing 10, a tray 12, transmission means 14 (not shown in FIG. 1), a cylindrical transparent reservoir 16, a cylindrical holder 18 (not shown to in FIG. 1), and an optical scanning assembly 20. The tray 12 is disposed in the housing 10, and the transmission means 14 is disposed in the housing for rotating the tray 12. Referring to FIG. 2A, it is preferable that the transmission means 14 is disposed under the tray 12 and configured of a plurality of gears, for example three cooperated gears 141, 142 and 143. The cylindrical transparent reservoir 16 is held on the tray 12 so that the cylindrical transparent reservoir 16 can synchronously rotate with the tray 12 driven by the transmission means 14. The cylindrical transparent reservoir 16 contains a predetermined amount of a fluid sample (not shown in FIG. 1) to be analyzed. Referring to FIG. 2B, the cylindrical holder 18 has a plurality of hollow frames 181 formed around the surrounding thereof each of which holding a test paper 182 having an unique color change in a predetermined location thereof sensitive to at least one specific substance in the fluid sample. The cylindrical holder 18 is disposed in the cylindrical transparent reservoir 16 and the level of the fluid sample contained in the cylindrical transparent reservoir 16 exceeds the bottom of each test paper 182 in order that the fluid sample can be absorbed by each test paper 182 by capillary action, thereby in response to a specific substance in the fluid sample, a pattern formed of a control bar 183 and a target bar 184 respectively having unique color change in a predetermined location of each test paper 182 is shown. The control bar 183 is located on a top portion of the test paper 182, and has a color change sensitive to the fluid sample to ensure that the amount of the fluid sample is sufficient to be sucked throughout all the area of the test paper 182 having been impregnated with target bars 184. The color change in the location of the target bar 184 means a specific substance presents in the fluid sample. However, the pattern shown in the test paper 182 is determined by the grades of the test paper 182. There are several grades of test paper respectively capable of testing one substance, two substances, three substances, and six substances etc. in the fluid sample. FIG. 2B shows the patterns of the test papers 182 each of which only used to test one specific substance in the fluid sample.

The optical scanning assembly 20 is fastened beside the cylindrical transparent reservoir 16 for capturing an image of the pattern shown on each test paper 182 upon rotating the cylindrical transparent reservoir 16, and converting the image to electronic signals, thereby the specific substances contained in the fluid sample are analyzed and identified via the image information captured from each test paper 182. For example, the specific substances and their quantities in the fluid sample are analyzed in accordance with the image positions related to and the gray levels thereof. Referring to FIG. 2C, a scanning head 200 of a general scanning system can be used as the optical scanning assembly 20 of the present apparatus 1. Thus, the optical scanning assembly 20 includes a linear light source 201 positioned to parallel the cylindrical transparent reservoir 16 in a longitudinal direction (see FIG. 1), a set of mirrors 202, 203 and 204, a lens system 205 and a photosensitive device 206, such as a charge-coupled device (CCD). The mirrors 202, 203 and 204 guide the illuminating light of the linear light source 201 reflected from each test paper 182 to the lens system 205 and thereby focusing to the photosensitive device 206. Consequently, the image information captured from each test paper 182 is analyzed and processed by the known image processing technology. The specific substances presenting in the fluid sample thus can be reliably identified qualitatively and quantitatively.

In accordance with the first preferred embodiment, the fluid sample can be a biological fluid collected from a test subject, such as a urine specimen fluid. In view of the present apparatus 1, the present invention provides means capable of detecting the presence of drugs of abuse rapidly and accurately. Such drugs of abuse capable of being detected include cocaine, morphine, heroin, codeine and other opiates etc. depending on what kind of test paper is used.

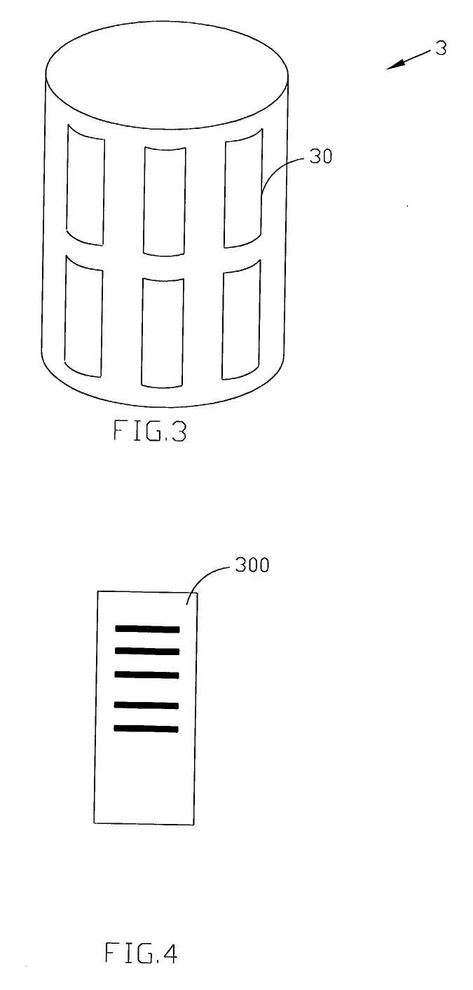

FIG. 3 is a schematic perspective view of a cylindrical holder 3 used in a second preferred embodiment of the present invention. The cylindrical holder 3 has a plurality of hollow frames 30 formed around the surrounding thereof. It is preferable that several rows of hollow frames 30 are arranged in different height levels, as shown in FIG. 3. Referring to FIG. 4, a test paper 300 having tested a fluid sample and showing a pattern in response to the fluid sample is held in each hollow frame 30 of the cylindrical holder 3. In the second preferred embodiment, the cylindrical holder 3 instead of the cylindrical transparent reservoir 16 is held on the tray 12, and synchronously rotates with the tray 12 driven by the transmission means 14. The optical scanning assembly 20 captures the image information of each test paper 300 upon rotating the cylindrical holder 3. In accordance with the image information captured from the test paper 300, the specific substances present in the fluid sample having been tested by the test paper 30 are analyzed and identified qualitatively and quantitatively. Since each test paper 300 has tested the fluid sample prior to placing in the hollow frame 30, each of the test papers 300 can test a respective fluid sample to be analyzed in previous. Therefore, the second preferred embodiment of the present invention provides means capable of simultaneously detecting the presence of drugs of abuse for different test subjects. As shown in FIG. 4, a higher grade's test paper 300 that can display different color changes in different locations thereof in response to respective substances present in the tested fluid sample is preferably used in the second preferred embodiment. Therefore, it is more convenient and more effective to use means of the second preferred embodiment of the present invention to monitor drugs of abuse so as to satisfy the demand of the currently increasing rise of the use of abuse-type drugs.

In addition, the configuration of the present apparatus is suitable to be shrank and designed to a portable device, facilitating a user to carry about with himself/herself. Moreover, the present apparatus is not only limited to monitor specific substances present in a fluid, which also can be used as a scanner that can capture image information of a cylindrical-shaped object held on the rotated tray.

The embodiments are only used to illustrate the present invention, not intended to limit the scope thereof. Many modifications of the embodiments can be made without departing from the spirit of the present invention.

What is claimed is:

1. An apparatus for monitoring specific substances in a fluid, comprising:
a housing;
a tray disposed in said housing;
transmission means disposed in said housing for rotating said tray;
a cylindrical transparent reservoir held by said tray so that said cylindrical transparent reservoir synchronously rotates with said tray, said cylindrical transparent reservoir containing a fluid sample to be analyzed;
a cylindrical holder having a plurality of hollow frames formed around the surrounding thereof each of which holding a test paper having an unique color change in a predetermined location thereof sensitive to at least one specific substance in said fluid sample, said cylindrical holder disposed in said cylindrical transparent reservoir so that the level of said fluid sample contained in said cylindrical transparent reservoir exceeds the bottom of each said test paper and said fluid sample is absorbed by each said test paper by capillary action; and
an optical scanning assembly fastened beside said cylindrical transparent reservoir for capturing an image of a pattern displayed on each said test paper in response to said fluid sample upon rotating said cylindrical transparent reservoir, and converting the image to electronic signals, thereby the specific substances contained in said fluid sample are analyzed and identified via the image information captured from each said test paper.

2. The apparatus of claim 1, wherein said transmission means is disposed under said tray and including a plurality of gears.

3. The apparatus of claim 1, wherein said optical scanning assembly includes a linear light source, a set of mirrors, a lens system and a photosensitive device, said linear light source paralleling said cylindrical transparent reservoir in a longitudinal direction, said mirrors guiding the illuminating light of said linear light source reflected from each said test paper to said lens system and thereby focusing to said photosensitive device.

4. The apparatus of claim 3, wherein said photosensitive device comprises a charge-coupled device.

5. The apparatus of claim 1, wherein said fluid sample comprises a biological specimen fluid.

6. The apparatus of claim 5, wherein said fluid sample comprises a urine specimen fluid.

7. The apparatus of claim 1, wherein said test paper is a kind of test paper for testing drugs of abuse.

8. An apparatus for monitoring specific substances in a fluid, comprising:
a housing;
a tray disposed in said housing;
transmission means disposed in said housing for rotating said tray;
a cylindrical holder having a plurality of hollow frames formed around the surrounding thereof each of which holding a test paper having tested a fluid sample to be analyzed and a pattern therefor displayed thereon in response to at least one specific substance in said fluid sample, said cylindrical holder held by said tray so that said cylindrical holder synchronously rotates with said tray; and
an optical scanning assembly fastened beside said cylindrical holder for capturing an image of the pattern displayed on each said test paper upon rotating said cylindrical holder, and converting the image to electronic signals, thereby the specific substances in said fluid sample are analyzed and identified via the image information captured from each said test paper.

9. The apparatus of claim 8, wherein said transmission means is disposed under said tray and including a plurality of gears.

10. The apparatus of claim 8, wherein said cylindrical holder having a plurality of said hollow frames arranged in different height levels.

11. The apparatus of claim 8, wherein said test paper is a kind of test paper for testing drugs of abuse.

12. The apparatus of claim 8, wherein each said test paper has tested a respective fluid sample prior to placed in said hollow frame of said cylindrical holder so that each said test paper has a pattern displayed thereon in response to the respective fluid sample.

13. The apparatus of claim 8, wherein said optical scanning assembly includes a linear light source, a set of mirrors, a lens system and a photosensitive device, said linear light source paralleling said cylindrical holder in a longitudinal direction, said mirrors guiding the illuminating light of said linear light source reflected from each said test paper to said lens system and thereby focusing to said photosensitive device.

14. The apparatus of claim 13, wherein said photosensitive device includes a charge-coupled device.

15. An apparatus for capturing an image of a cylindrical-shaped object, comprising:
a housing;
a tray disposed in said housing for holding a cylindrical-shaped object;
transmission means disposed in said housing for rotating said tray; and
an optical scanning assembly fastened beside said tray for capturing an image of said cylindrical-shaped object upon rotating said tray and converting the image to an electronic signal.

16. The apparatus of claim 15, wherein said transmission means is disposed under said tray and includes a plurality of gears.

17. The apparatus of claim 15, wherein said optical scanning assembly includes a linear light source, a set of mirrors, a lens system and a photosensitive device, said linear light source paralleling said cylindrical-shaped object in a longitudinal direction, said mirrors guiding the illuminating light of said linear light source reflected from said cylindrical-shaped object to said lens system and thereby focusing to said photosensitive device.

18. The apparatus of claim 17, wherein said photosensitive device includes a charge-coupled device.
